(19) United States
(12) Patent Application Publication
(10) Pub. No.: US 2025/0237861 A1
(43) Pub. Date: Jul. 24, 2025

(54) POLARIZER ASSEMBLY AND SPECTROSCOPIC ELLIPSOMETER INCLUDING THE SAME

(71) Applicant: Samsung Electronics Co., Ltd., Suwon-si (KR)

(72) Inventors: Jiyong Shin, Suwon-si (KR); Kihun Kang, Suwon-si (KR); Changhyeong Yoon, Suwon-si (KR); Hyukjoon Cho, Suwon-si (KR); Taejoong Kim, Suwon-si (KR); Kyoungwhan Oh, Suwon-si (KR); Taeyong Jo, Suwon-si (KR); Kyungwook Han, Suwon-si (KR)

(21) Appl. No.: 18/964,954

(22) Filed: Dec. 2, 2024

(30) Foreign Application Priority Data
Jan. 18, 2024 (KR) 10-2024-0008096

(51) Int. Cl. G02B 26/00; G01N 21/21; G02B 27/28

(52) U.S. Cl. CPC G02B 26/007; G01N 21/211; G02B 27/281; G01N 2021/213; G01N 2201/0683

(57) ABSTRACT

A polarizer assembly of a spectroscopic ellipsometer includes a motor, a motor adapter mounted on the motor and having a coupling surface facing the motor, a first attachment surface opposite the coupling surface, and an adapter through hole, and a polarizer holder having a first holder and a second holder that are fastened to each other to fixedly hold a polarizer between a first fastening surface of the first holder and a second fastening surface of the second holder, the first holder and the second holder respectively having a first through hole and a second through hole that are aligned with each. A first magnet is provided in in the first attachment surface and a second magnet is provided in a second attachment surface of the first holder such that the polarizer holder is detachably attached to the motor adapter by magnetic force.

### PRIORITY STATEMENT

This application claims priority under 35 U.S.C. § 119 to Korean Patent Application No. 10-2024-0008096, filed on Jan. 18, 2024, in the Korean Intellectual Property Office (KIPO), the contents of which are herein incorporated by reference in their entirety.

### BACKGROUND

### 1. Field

Example embodiments relate to a polarizer assembly and a spectroscopic ellipsometer including the same. More particularly, example embodiments relate to a polarizer assembly having a polarizer rotatable by a hollow motor and a spectroscopic ellipsometer including the same.

### 2. Description of the Related Art

Spectral elliptic polarization analysis technology is a technology that irradiates a sample with polarized light and measures a change in a polarization state of a reflected light. The change in polarization (spectrum) according to the wavelength depends on physical properties and a structure of the sample. The physical properties and structure information of the sample may be extracted and measured using the spectrum obtained through the spectroscopic elliptic spectrometry. The spectroscopic elliptic spectrometer may include a polarization state generator and a polarization stage analyzer, and the polarization state generator and the polarization stage analyzer may have a polarizer that is rotatable by a hollow motor. If the polarizer is directly assembled to a body of an optical system body in a narrow space within the facility using a polarizer fixing apparatus, the polarizer may be damaged or the installation time may increase. When the polarizer is fixed using adhesive, when the adhesive cures, distortion may occur and accordingly the polarizer may be tilted, causing an optical path deviation phenomenon to occur.

### SUMMARY

Example embodiments provide a polarizer assembly that provides improved component assemblability, assembly precision and repeatability, and can reduce assembly time.

Example embodiments provide a spectroscopic ellipsometer including the polarizer assembly.

According to example embodiments, a polarizer assembly includes, a hollow motor having a rotating part and a through passage extending therethrough; a motor adapter mounted on a surface of the rotating part of the hollow motor, the motor adapter having a coupling surface facing the hollow motor, a first attachment surface opposite the coupling surface, and an adapter through hole aligned with the through passage of the hollow motor and through which light traveling through the hollow motor passes; and a polarizer holder having a first holder and a second holder that are fastened to each other to fixedly hold a polarizer between a first fastening surface of the first holder and a second fastening surface of the second holder that opposes the first fastening surface, the first holder and the second holder respectively having a first through hole and a second through hole that are aligned with each other when the first holder and the second holder are fastened to each other, and the polarizer holder having a second attachment surface facing the first attachment surface. A first magnet is provided in the first attachment surface and a second magnet is provided in the second attachment surface such that the polarizer holder is detachably attached to the motor adapter by magnetic force between the first magnet and the second magnet.

According to example embodiments, a polarizer assembly includes, a motor adapter having a coupling surface for fixedly attaching to one surface of a rotating part of a hollow motor and having an adapter through hole through which light traveling through the hollow motor passes; a first holder detachably attached to the motor adapter, the first holder having a first through hole that is aligned with the adapter through hole when the first holder is attached to the motor adapter; a second holder fastened to the first holder, the second holder having a second through hole that is aligned with the first through hole when the second holder is fastened to the first holder; and a polarizer fixedly held between the first holder and the second holder that are fastened to each other. At least one magnet is provided in each of attachment surfaces of the motor adapter and the first holder that face each other such that the first holder is detachably attached to the motor adapter by magnetic force between the at least one magnet provided in each of the first holder and the second holder.

According to example embodiments, a polarizer assembly includes a motor adapter having a coupling surface for attaching to a surface of a rotating part of a hollow motor, the motor adapter having an adapter through hole through which light traveling through the hollow motor passes; and a polarizer holder having a first holder and a second holder that are fastened to each other to fixedly hold a polarizer between opposing fastening surfaces of the first holder and the second holder, the first holder and the second holder respectively having a first through hole and a second through hole that are aligned with each other when the first holder and the second holder are fastened to each other. At least one magnet is provided in each of attachment surfaces of the motor adapter and the first holder that face each other such that the polarizer holder is detachably attached to the motor adapter by magnetic force between the at least one magnet is provided in each of the attachment surfaces of the motor adapter and the first holder. At least one alignment pin is provided on the attachment surface of the motor adapter, and at least one alignment pin hole into which the at least one alignment pin is inserted is provided in the attachment surface of the first holder.

According to example embodiments, a spectroscopic ellipsometer includes a light source configured to irradiate a sample surface with incident light, a polarizer assembly disposed on an optical path of the incident light to be incident on the sample surface, the polarizer assembly including a polarizer rotatable at a first angle to adjust a polarization direction of the incident light, an analyzer assembly disposed on an optical path of light reflected from the sample surface, the analyzer assembly including an analyzer rotatable at a second angle to adjust a polarization direction of the reflected light, a light detector configured to receive the light passing through the analyzer to collect image data, and a controller configured to control operations of the polarizer and the analyzer to obtain an image signal from the sample at a combination of the first angle of the polarizer and the second angle of the analyzer. Each of the polarizer assembly and the analyzer assembly includes, a hollow motor; a motor adapter mounted on one surface of a rotating part of the hollow motor, the motor adapter having an adapter through hole through which light traveling through the hollow motor passes; and a polarizer holder having a first holder and a second holder that are fastened to each other to fixedly hold the polarizer between opposing fastening surfaces of the first holder and the second holder, the first holder and the second holder respectively having a first through hole and a second through hole that are connected to each other when the first holder and the second holder are fastened to each other. At least one magnet is provided in each of attachment surfaces of the motor adapter and the first holder that face each other such that the polarizer holder is detachably attached to the motor adapter by magnetic force.

According to example embodiments, a polarizer assembly of a spectroscopic ellipsometer may include a polarizer holder assembly that is detachably mounted on a hollow motor. The polarizer holder assembly may include a motor adapter that is mounted on one surface of a rotating part of the hollow motor and a polarizer holder that is detachably attached to the motor adapter by magnetic force. The polarizer holder may include a first holder and a second holder that are fastened to each other by fastening bolts to fixedly hold a polarizer therebetween.

The polarizer holder may be assembled to fixedly hold the polarizer in a sandwich manner outside the facility, and the assembled polarizer holder may be attached to the motor adapter by magnetic force rather than by bolt fastening. Accordingly, component assembly, assembly precision, and repeatability may be improved.

In addition, an O-ring may be pressed through surface contact with the polarizer, and the pressed polarizer may be aligned with a bottom surface of a polarizer receiving groove of the second holder having the guaranteed flatness, to thereby prevent tilting or twisting of the polarizer and prevent damage when the polarizer is installed.

### BRIEF DESCRIPTION OF THE DRAWINGS

Example embodiments will be more clearly understood from the following detailed description taken in conjunction with the accompanying drawings. FIGS. 1 to 19 represent non-limiting, example embodiments as described herein.

FIG. 1 is a block diagram illustrating a spectroscopic ellipsometer in accordance with example embodiments.

FIG. 2 is a view illustrating a light incident on a sample surface and a light reflected therefrom.

FIG. 3 is a view illustrating an angle set according to a combination of a polarizer angle and an analyzer angle of the spectroscopic ellipsometer in FIG. 1.

FIG. 4 is a view illustrating spectral images for wavelengths detected by a detector of the spectroscopic ellipsometer in FIG. 1.

FIG. 5 is a view illustrating a light intensity spectrum for wavelengths in one pixel in FIG. 4.

FIG. 6 is a perspective view illustrating a polarizer assembly installed in a spectroscopic ellipsometer in according to example embodiments.

FIG. 7 is an exploded perspective view illustrating processes of assembling the polarizer assembly of FIG. 6.

FIG. 8 is an exploded perspective view of the polarizer assembly of FIG. 7 when viewed from the left.

FIG. 9 is an exploded perspective view illustrating a motor adapter mounted on a hollow motor in FIG. 6.

FIG. 10 is an exploded perspective view illustrating a polarizer holder attached to the motor adapter of FIG. 9.

FIG. 11 is an exploded perspective view of the polarizer holder of FIG. 10 when viewed from the left.

FIG. 12 is a plan view illustrating a motor adapter of a polarizer assembly in accordance with example embodiments.

FIG. 13 is a cross-sectional view taken along the line A-A′ in FIG. 12.

FIG. 14 is a cross-sectional view taken along the line B-B′ in FIG. 12.

FIG. 15 is a plan view illustrating a first holder of a polarizer assembly in accordance with example embodiments.

FIG. 16 is a cross-sectional view taken along the line C-C′ in FIG. 15.

FIG. 17 is a cross-sectional view taken along the line D-D′ in FIG. 15.

FIG. 18 is a plan view illustrating a second holder of a polarizer assembly in accordance with example embodiments.

FIG. 19 is a cross-sectional view taken along the line E-E′ in FIG. 18.

### DETAILED DESCRIPTION OF EXAMPLE EMBODIMENTS

Hereinafter, example embodiments will be explained in detail with reference to the accompanying drawings in which various embodiments are shown. The invention may, however, be embodied in many different forms and should not be construed as limited to the example embodiments set forth herein. It should also be emphasized that the disclosure provides details of alternative examples, but such listing of alternatives is not exhaustive. Furthermore, any consistency of detail between various examples should not be interpreted as requiring such detail. The language of the claims should be referenced in determining the requirements of the invention.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

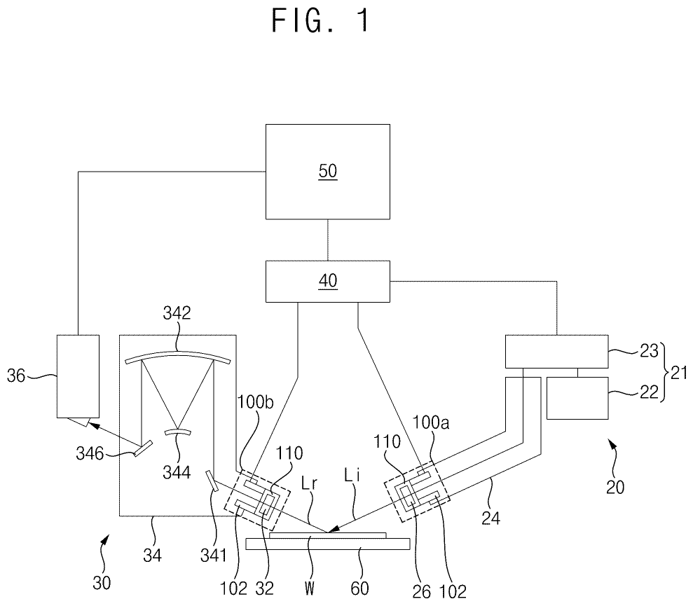

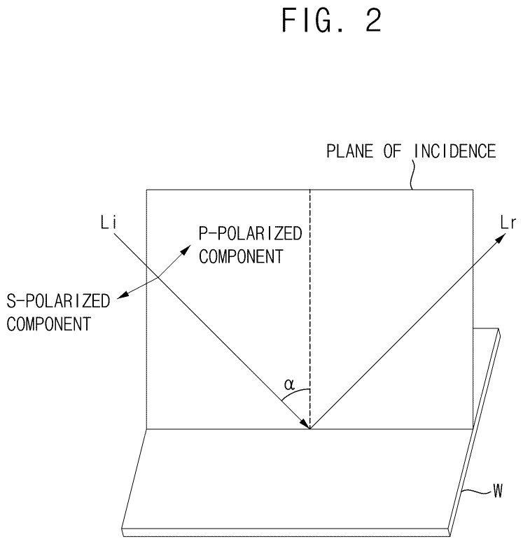

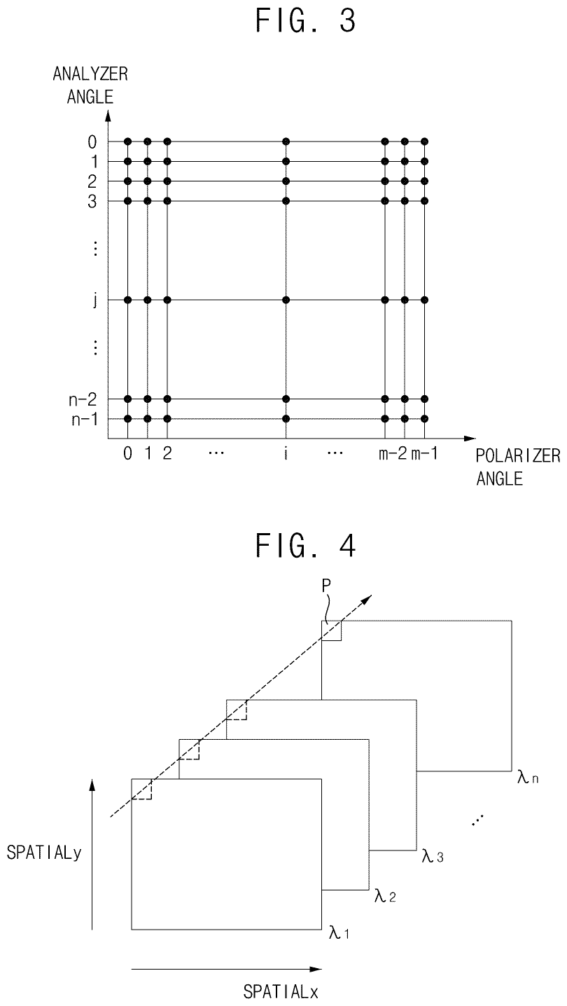

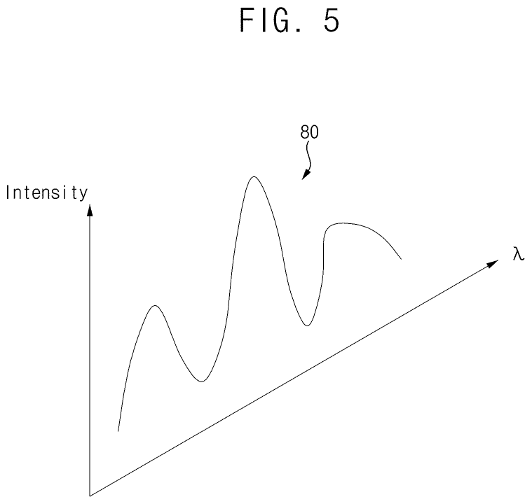

FIG. 1 is a block diagram illustrating a spectroscopic ellipsometer in accordance with example embodiments. FIG. 2 is a view illustrating a light incident on a sample surface and a light reflected therefrom. FIG. 3 is a view illustrating an angle set according to a combination of a polarizer angle and an analyzer angle of the spectroscopic ellipsometer in FIG. 1. FIG. 4 is a view illustrating spectral images for wavelengths detected by a detector of the spectroscopic ellipsometer in FIG. 1. FIG. 5 is a view illustrating a light intensity spectrum for wavelengths in one pixel in FIG. 4.

Referring to FIGS. 1 to 5, a spectroscopic ellipsometer 10 may include a light irradiator 20 that irradiates a sample surface such as a wafer W with a polarized light Li. The direction and polarization direction of the polarized light Li changes when reflected from the sample surface A detector 30 receives a light Lr reflected from the wafer W and detects an image according to a polarization state at each of a plurality of points on the sample surface. In addition, the spectroscopic ellipsometer 10 may further include a controller 40 that controls operations of the light irradiator 20 and the detector 30, a processor 50 that processes data associated with the detected image, and a stage 60 that supports the wafer W.

In example embodiments, the spectroscopic ellipsometer 10 may be an imaging elliptic spectroscopy apparatus of a surface measurement type that measures multiple points instead of one point on the wafer surface. In addition, the spectroscopic ellipsometer 10 may irradiate the wafer surface with light having a broadband wavelength in order to obtain desired information on a miniaturized semiconductor structure, thickness, physical properties, etc. In some embodiments of an imaging elliptic spectroscopy, the light irradiator 20 may include a monochromator 23 that transmits a narrow wavelength band from a wide wavelength band, and a light detector 36 may include a camera as a two-dimensional image sensor.

The wafer W may be a semiconductor substrate. For example, the semiconductor substrate may include silicon, strained silicon (strained Si), silicon alloy, silicon carbide (SiC), silicon germanium (SiGe), silicon germanium carbide (SiGeC), germanium, germanium alloy, gallium arsenide (GaAs), indium arsenide (InAs) and III-V semiconductors, II-VI semiconductors, or a combination thereof. In addition, if necessary, the wafer may be an organic plastic substrate rather than the semiconductor substrate.

The wafer W may be supported on the stage 60. The stage 60 may move the wafer W to a specific position during a measurement process. For example, the stage 60 may move the wafer W in a first direction or a second direction perpendicular to the first direction. The stage 60 may be supported by bearings allowing the stage 60 to translate in a horizontal plane. A motor or actuator may cause the stage 60 to move in the horizontal plane.

As illustrated in FIGS. 1 and 2, the light irradiator 20 may irradiate the surface of the wafer W with the polarized light Li whose direction and polarity may change when passing through layers of the wafer and/or when reflected from layers of the wafer. The light irradiator 20 may emit the polarized light Li at a predetermined angle with respect to the surface of the wafer W. When the incident light Li is obliquely incident on the sample surface, a plane of incidence may be defined by an incidence path and a reflection path of the light. The oscillation direction of the electric field of the electromagnetic wave of the light may be perpendicular to the propagation direction of light. Here, an electric field component parallel to the plane of incidence may be referred to as p-wave, and an electric field component perpendicular to the plane of incidence may be referred to as s-wave. When the p-wave and the s-wave are incident on the sample and reflected therefrom, the amplitude and the phase of the p-wave and the s-wave may change independently of each other.

In particular, the light irradiator 20 may include a light source assembly 21 and an illumination assembly 24. The light source assembly 21 may include a light source 22 and a monochromator 23, and the illumination assembly 24 may include an illumination optical system and a polarizer 26 as a polarization state generator (PSG). The polarization state generator may include a first polarizer assembly 100a including the polarizer 26, which may be fixedly provided therein. The first polarizer assembly 100a may include a hollow motor 102 and a polarizer holder assembly 110 that is mounted on the hollow motor 102 and holds the polarizer 26. The hollow motor 102 may be a motor having a passage therethrough such that light may be passed through the passage of the hollow motor 102. The passage may extend in a direction parallel to an axis of rotation of the motor.

The light source 22 may generate broadband light. For example, the light source 22 may include a broadband light source such as a laser plasma light source. The wavelength band of the light generated by the light source 22 may vary depending on the object to be measured, and may generally have a bandwidth ranging from the Ultraviolet (UV) band to the Near Infrared (NIR) band. The monochromator 23 may extract or filter light of a specific wavelength from the light generated from the light source 22. For example, the monochromator 23 may extract monochromatic light from broadband light or filter out light other than the monochromatic light and the illumination assembly 24 may illuminate the monochromatic light therethrough.

The light emitted from the light source assembly 21 may travel along a path of the incident light Li in the illumination assembly 24. Light emitted from the light source assembly 21 into the illumination assembly 24 may be converted into parallel light by a collimator lens of the illumination optical system. An illumination body of the illumination assembly 24 may extend in the same direction as the path of the incident light Li, and the polarizer 26 and the first polarizer assembly 100a may be fixedly installed in the illumination body. The incident light Li may be irradiated to a measurement area of the wafer W placed on the stage 60 and irradiated through the polarizer 26 in the first polarizer assembly 100a.

The polarization state generator may adjust a polarization direction of the incident light Li. The polarization state generator may include the hollow motor 102 as a rotating part that can adjust the polarization direction. The hollow motor 102 may rotate to a first angle. The polarizer 26 may be rotated by the hollow motor 102 to be orientated at the first angle and the first angle of the polarizer 26 may be maintained to have a constant value. The hollow motor 102 may be electrically connected to the controller 40, and the controller 40 may send control signals to the hollow motor 102 to adjust the first angle of the hollow motor 102. The polarizer 26 may be a polarizing filter including a wire grid provided on a rotation shaft of the hollow motor.

Accordingly, the incident light Li as monochromatic light extracted from the light generated from the light source 22 may be directed to the measurement area on the wafer W, and the reflected light Lr reflected from the wafer W may be collected into the detector 30.

The detector 30 may receive the light Lr reflected from the wafer W to detect a two-dimensional image of the sample surface according to a change in polarization of the reflected light Lr. The detector 30 may include an analyzer 32 as a polarization state analyzer (PSA) p, an imaging mirror optical system 34, and a light detector 36. The imaging mirror optical system 34 and the analyzer 32 may be collectively referred to as an imaging assembly. The imaging assembly may be housed in an optical body which may be referred to as a collecting body of the imaging assembly. The polarization state analyzer may include a second polarizer assembly 100b including the analyzer 32 which may be fixedly provided therein. The second polarizer assembly 100b may include a hollow motor 102 and a polarizer holder assembly 110 that is mounted on the hollow motor 102 and holds the analyzer 32. The second polarizer assembly 100b may be fixedly installed in the collecting body of the imaging assembly.

The polarization state analyzer may adjust a polarization direction of the reflected light Lr reflected from the wafer W. The polarization state analyzer may include the hollow motor 102 as a rotating part, and the hollow motor 102 may rotate to a second angle. The hollow motor 102 may be electrically connected to the controller 40, and the controller 40 may send a control signal to the hollow motor 102 to adjust the second angle of the hollow motor 102. The analyzer 32 may transmit only a linearly polarized light component corresponding to the second angle. The analyzer 32 may be a polarizing filter including a wire grid provided on a rotation shaft of the hollow motor 102.

The imaging mirror optical system 34 may image the reflected light Lr passing through the analyzer 32 on a light receiving plane of the light detector 36. The imaging mirror optical system 34 may have an object plane and an imaging plane as conjugate planes. The object plane of the imaging mirror optical system 34 may be positioned on the surface of the wafer W, and the imaging plane of the imaging mirror optical system 34 may be positioned on the light receiving plane of the light detector 36.

The imaging mirror optical system 34 may have a relatively long working distance WD. The analyzer 32 may be positioned between the object plane and the imaging mirror optical system 34. In this case, in consideration of a size of the hollow type motor, the imaging mirror optical system 34 may be designed to have a relatively long working distance.

In example embodiments, the imaging mirror optical system 34 may be a mirror-based imaging optical system including at least two mirrors. In the case of an existing lens-based optical system, since a large number (e.g., 8 to 16) lenses are used to satisfy optical performance of a broadband wavelength, transmittance may be reduced and chromatic aberration may occur. However, when the mirror-based imaging optical system is used, it may be possible to minimize chromatic aberration and secure transmittance in a specific wavelength region.

In particular, the imaging mirror optical system 34 may include a first mirror 342 having a concave reflective surface, a second mirror 344 having a convex reflective surface, and a third mirror 346. The first mirror 342 may be a concave spherical mirror, and the second mirror 344 may be a convex spherical mirror. The first mirror 342 and the second mirror 344 may be arranged to produce at least three reflections within the optics. The first mirror 342 and the second mirror 344 may form concentric circles. The centers of the radii of curvature of the first mirror 342 and the second mirror 344 may coincide with one point. The radius of the first mirror 342 may be twice the radius of the second mirror 344. A magnification of the imaging mirror optical system 34 including the first and second mirrors 342 and 344 may be one.

The object plane may be positioned at a first conjugation point, and the imaging plane may be positioned at a second conjugation point. The first conjugation point and the second conjugation point may be conjugates of one another. That is, the reflected light Lr from the first conjugate point may be incident and primarily reflected to the first mirror 342 of the imaging mirror optical system 34, and the primarily reflected light may be secondarily reflected by the second mirror 344 and proceed toward the first mirror again, and then, may be thirdly reflected by the first mirror 342 and travel toward the second conjugate position.

The reflected light Lr reflected from the wafer surface may pass through the analyzer 32, and the reflected light Lr that has passed through the analyzer 32 may impinge on a first portion of the first mirror 342. The reflected light Lr passing through the analyzer 32 may be incident off-axis on the first portion of the first mirror 342. The first portion of the first mirror 342 may firstly reflect the reflected light to be directed toward the second mirror 344. The second mirror 344 may secondarily reflect the reflected light to be directed toward a second portion of the first mirror 342. The second portion of the first mirror 342 may thirdly reflect the reflected light, and the thirdly reflected light from the second portion of the first mirror 342 may be focused on the light receiving plane of the light detector 36 through the third mirror 346 which is a plane mirror.

The third mirror 346 may deflect the light reflected from the second portion of the first mirror 342 toward the light detector 36. The third mirror 346 may redirect the light reflected from the second portion of the first mirror 342 in order to change a position of the light detector 36.

In addition, the imaging mirror optical system 34 may further include a fourth mirror 341 configured to redirect the reflected light passing through the analyzer 32. The fourth mirror 341 may be a plane mirror. The fourth mirror 341 may be configured to deflect the reflected light Lr passing through the analyzer 32 toward the first mirror 342 in order to change positions of the first to third mirrors 342, 344 and 346. Although it is not illustrated in the drawings, the imaging mirror optical system 34 may further include a compensation lens configured to compensate for chromatic aberration.

The light detector 36 may detect a spectral image from the reflected light Lr passing through the imaging mirror optical system 34. For example, the light detector 36 may detect a spectral image for a particular wavelength. The light detector 36 may include a camera as a two-dimensional image sensor capable of detecting the reflected light Lr.

The controller 40 may be connected to the monochromator 23, the first polarizer assembly 100a, the second polarizer assembly 100b, the light detector 36 and the processor 50 to control operations thereof. The controller 40 may receive an angle set according to a combination of the polarizer angle and the analyzer angle from the processor 50. The angle sets may be determined by the combination of the first angle of the polarizer 26 and the second angle of the analyzer 32. The controller 40 may control the polarizer 26 and the analyzer 32 according to the inputted angle set to change the first and second angles.

The polarizer 26 may rotate by an integer multiple (i) of a first unit angle, and the analyzer 32 may rotate by an integer multiple (j) of a second unit angle to produce an angle set of a particular combination. The first angle of the polarizer 26 may be a value obtained by multiplying the first unit angle by the integer multiple (i), and the second angle of the analyzer 32 may be a value obtained by multiplying the second unit angle by the integer multiple (j). The first and second unit angles may be set as an angle obtained by dividing 360 degrees by an integer of 8 or more. For example, an angle 10° obtained by dividing 360° by 36 may be set as the unit angle.

As illustrated in FIG. 3, when the rotation index i of the polarizer 26 is 0, 1, . . . , m−1, and the rotation index j of the analyzer 32 is 0, 1, . . . , n−1, the number of combinations of the first angle and the second angle may be m×n (m and n are natural numbers). In this case, sample analysis may be performed by obtaining m×n images for each wavelength.

The controller 40 may generate the angle set by changing the first and second angles according to a preset value. For example, the angle sets may be generated by maintaining the first angle of polarizer 26 at a constant value and varying the second angle of analyzer 32 or maintaining the second angle of analyzer 32 at a constant value and varying the first angle of the polarizer 26.

The processor 50 may receive spectral images (see FIG. 4) from the light detector 36. For example, the processor 50 may receive first spectral images (illustrated as one image in the drawing) corresponding to the angle sets and a first wavelength λ1 and second spectral images (illustrated as one image in the drawing) corresponding to the angle sets and a second wavelength 22 different from the first wavelength, from the light detector 36. Similarly, the processor 50 may receive spectral images corresponding to different wavelengths (λ3, . . . , λn). The processor 50 may generate a spectral matrix by using the spectral images. In addition, the processor 50 may generate a spectrum 80 (see FIG. 5) representing a change in light intensity for wavelengths in each pixel by using the spectral matrix.

As illustrated in FIG. 5, as indicated by arrows from the spectral images, a light quantity spectrum 80 for wavelengths may be obtained from a pixel P at the same position. The spectrum 80 may represent a change in intensity according to the wavelength of the reflected light Lr at a specific position (pixel).

As mentioned above, the spectroscopic ellipsometer 10 may measure electromagnetic field values of p-wave and s-wave while changing a combination of the angle sets. The first angle of the polarizer 26 may determine the polarization direction of the light incident on the sample, and the second angle of the analyzer 32 may determine the polarization direction of the light incident on the light detector 36 after reflecting from and/or passing through the sample. The first polarizer assembly 100a including the polarizer 26 fixedly held therein may be fixedly installed in the illumination body of the illumination assembly 24, and the second polarizer assembly 100b including the analyzer 320 fixed held therein may be fixedly installed in the collecting body of the imaging assembly. Each of the first and second polarizer assemblies 100a and 100b may include a polarizer holder assembly that holds the polarizers as the polarizer 26 and the analyzer 32, and the polarizer holder assembly may be detachably attached to the hollow motor 102 using a magnet rather than a bolt fastening method.

Hereinafter, the first and second polarizer assemblies will be explained in detail.

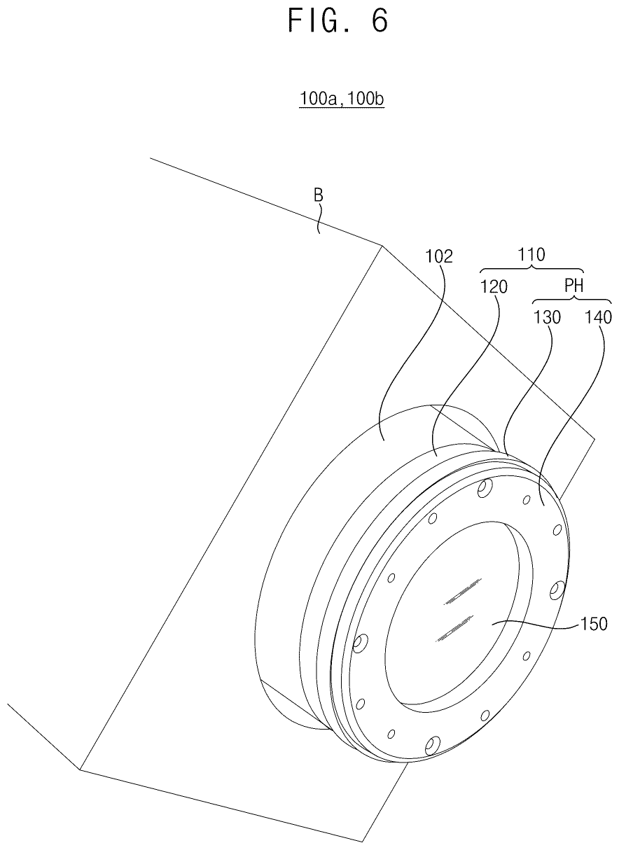

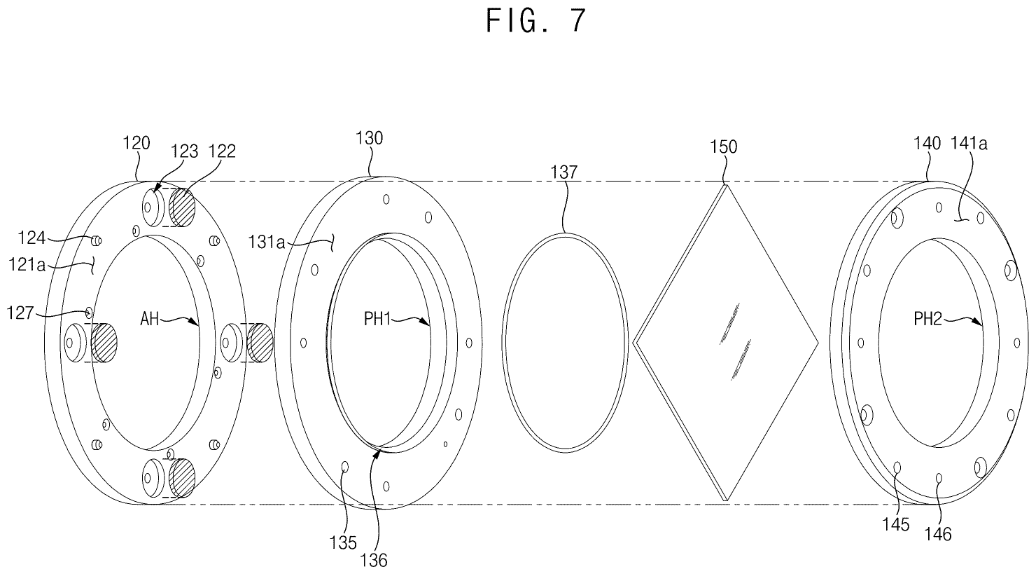

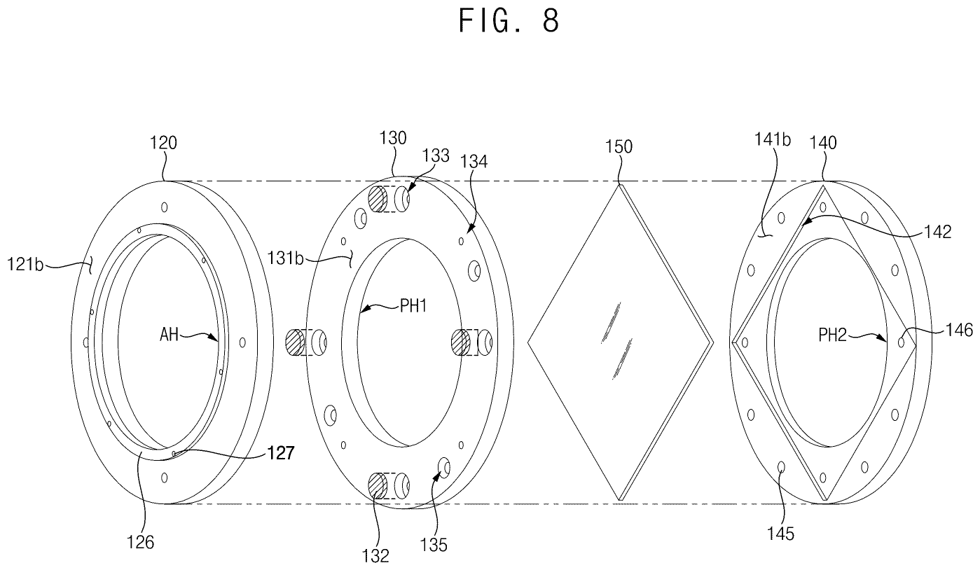

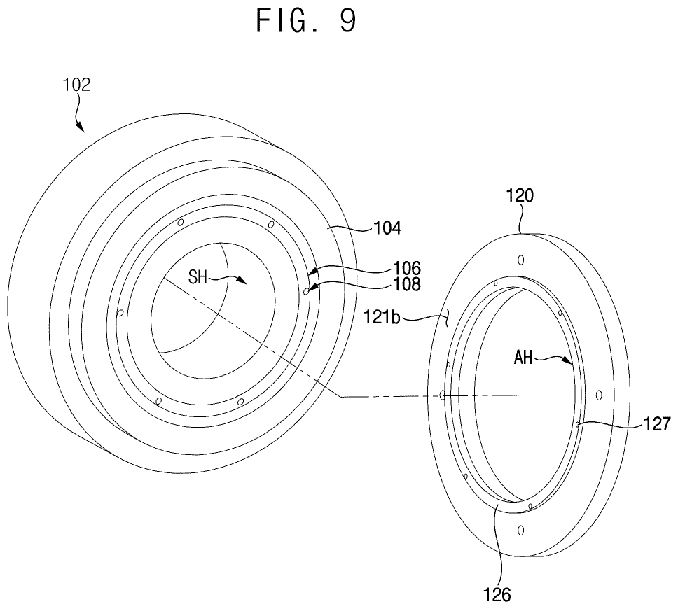

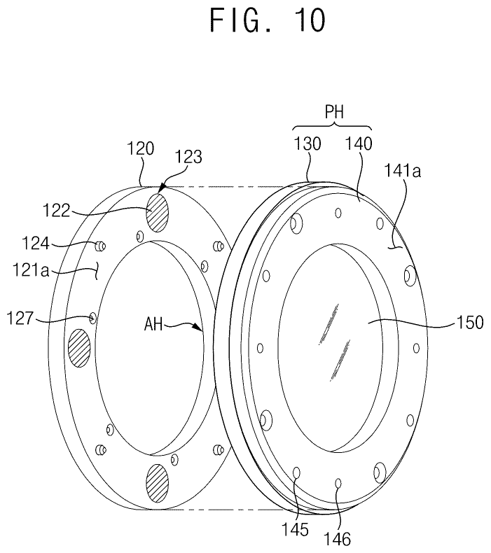

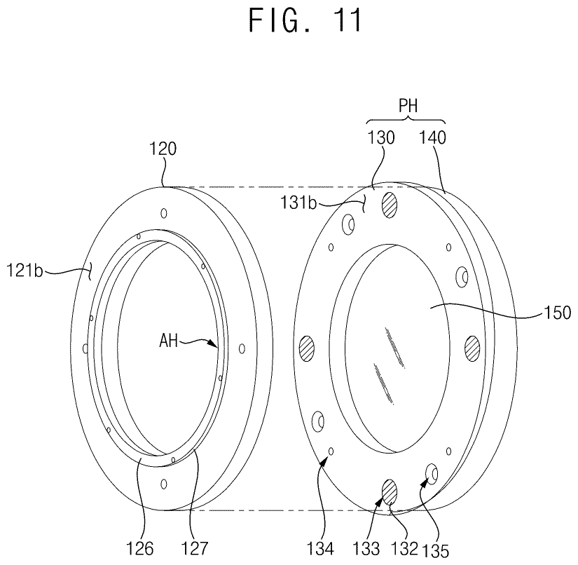

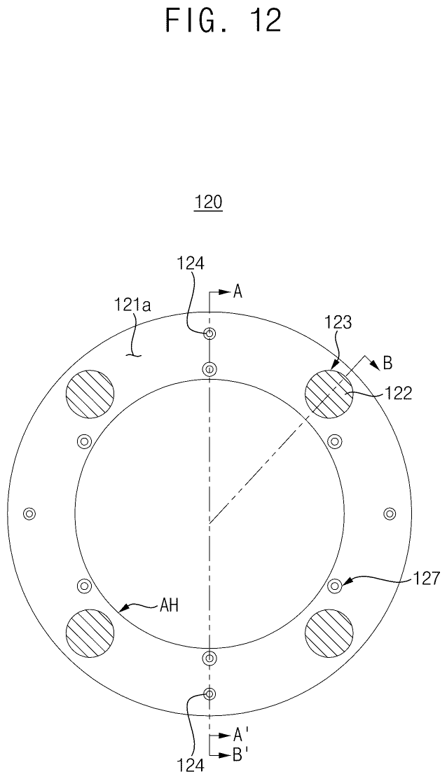

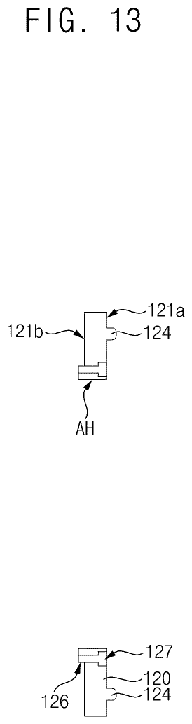

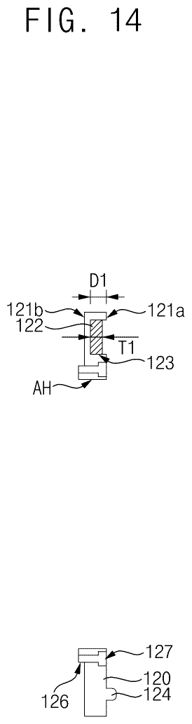

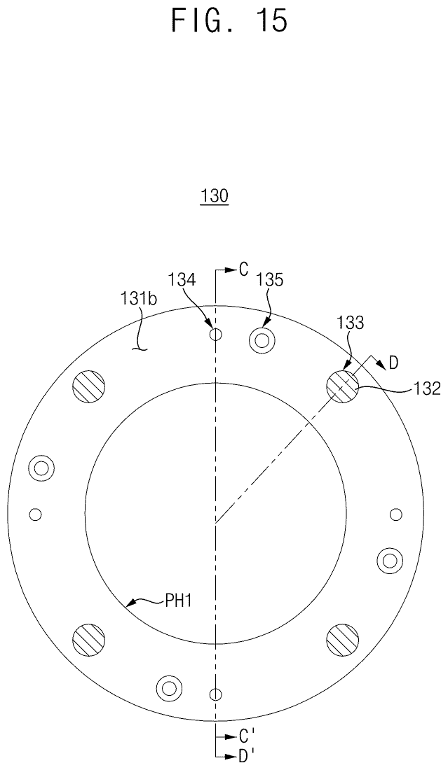

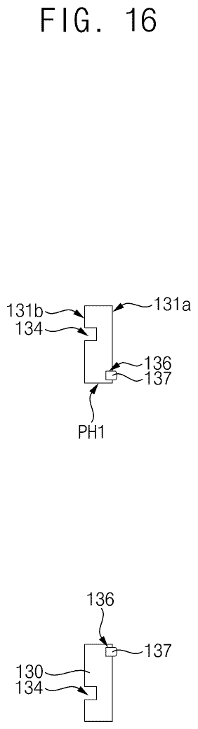

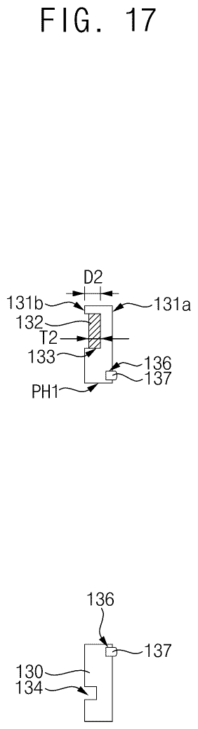

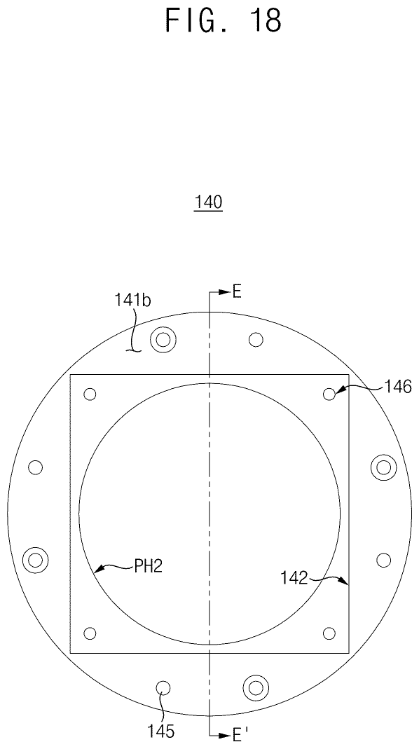

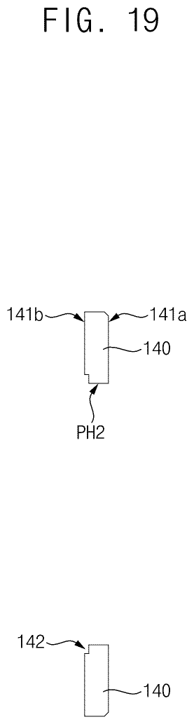

FIG. 6 is a perspective view illustrating a polarizer assembly installed in a spectroscopic ellipsometer in according to example embodiments. FIG. 7 is an exploded perspective view illustrating processes of assembling the polarizer assembly of FIG. 6. FIG. 8 is an exploded perspective view of the polarizer assembly of FIG. 7 when viewed from the left. FIG. 9 is an exploded perspective view illustrating a motor adapter mounted on a hollow motor in FIG. 6. FIG. 10 is an exploded perspective view illustrating a polarizer holder attached to the motor adapter of FIG. 9. FIG. 11 is an exploded perspective view of the polarizer holder of FIG. 10 when viewed from the left. FIG. 12 is a plan view illustrating a motor adapter of a polarizer assembly in accordance with example embodiments. FIG. 13 is a cross-sectional view taken along the line A-A′ in FIG. 12. FIG. 14 is a cross-sectional view taken along the line B-B′ in FIG. 12. FIG. 15 is a plan view illustrating a first holder of a polarizer assembly in accordance with example embodiments. FIG. 16 is a cross-sectional view taken along the line C-C′ in FIG. 15. FIG. 17 is a cross-sectional view taken along the line D-D′ in FIG. 15. FIG. 18 is a plan view illustrating a second holder of a polarizer assembly in accordance with example embodiments. FIG. 19 is a cross-sectional view taken along the line E-E′ in FIG. 18.

Referring to FIGS. 6 to 19, a polarizer assembly 100a, 100b of a spectroscopic ellipsometer may include a hollow motor 102 and a polarizer holder assembly 110 that is detachably mounted on the hollow motor 102 and fixedly holds a polarizer 150 as a polarizer or analyzer. The polarizer holder assembly 110 may include a motor adapter 120 that is mounted on one side of a rotating part 104 of the hollow motor 102 and a polarizer holder PH that is detachably attached to the motor adapter 120 and fixes the polarizer 150. The polarizer holder PH may be frame that houses the polarizer 150. The polarizer holder PH may include a first holder 130 and a second holder 140 that are coupled to each other with the polarizer 150 interposed therebetween to fixedly accommodate the polarizer 150. The first holder 130 may be a first subframe and the second holder 140 may be a second subframe that collectively house the polarizer 150 when the first subframe 130 and the second subframe are coupled to one another.

In example embodiments, the first polarizer assembly 100a, in which the polarizer 150 as a polarization state generator is fixedly held, may rotate the polarizer holder assembly 110 to a first angle using the hollow motor 102 to adjust a polarization direction of incident light (Li) incident on a sample surface. The second polarizer assembly 100b, in which the polarizer 150 as a polarization state analyzer is fixedly held, may rotate the polarizer holder assembly 110 to a second angle using the hollow motor 102 to polarize reflected light (Lr) reflected from the sample surface.

As illustrated in FIG. 6, the polarizer assemblies 100a and 100b may be provided on an optical body B of an illumination assembly or an imaging assembly. The hollow motor 102 may be fixed to one side of the optical body B, and the polarizer holder assembly 110 may be detachably mounted on the hollow motor 102. In order to replace a polarizer with a new second polarizer of specific specifications, the polarizer holder assembly including the first polarizer fixedly held therein may be separated from the hollow motor 102, and then, the new second polarizer 150 may be clamped within the polarizer holder PH outside the optical equipment, and the polarizer holder PH may be detachably attached to the motor adapter 120 that is mounted to the hollow motor 102.

As illustrated in FIGS. 7 to 11, the first holder 130 and the second holder 140 may be fastened to each other using fastening members such as fastening bolts. The first holder 130 and the second holder 140 fastened to each other may serve as the polarizer holder PH for fixedly holding the polarizer 150 therebetween. The polarizer holder PH may be attached to and detached from the motor adapter 120 using magnetic force. The motor adapter 120 may be fixed to one surface of the rotating part 104 of the hollow motor 102. The polarizer holder PH may be mounted on the hollow motor 102 via the motor adapter 120. The motor adapter 120 may serve as an adapter for mounting the polarizer holder PH on the hollow motor 102. Accordingly, the polarizer holder assembly 110 may be rotated by the hollow motor 102.

In particular, the motor adapter 120 may have a first surface 121a and a second surface 121b opposite to the first surface 121a. The first surface 121a may be an attachment surface for attachment to the polarizer holder PH, and the second surface 121a may be a coupling surface for coupling with the hollow motor 102. The motor adapter 120 may be a circular plate having an adapter passage hole AH for passing light traveling through a passage SH of the hollow motor 102.

The first holder 130 may have a third surface 131a and a fourth surface 131b opposite to the third surface 131a. The third surface 131a may be a fastening surface for fastening with the second holder 140, and the fourth surface 131b may be an attachment surface for attachment to the motor adapter 120. The first holder 130 may be a circular plate having a first through hole PH1. The second holder 140 may have a fifth surface 141a and a sixth surface 141b opposite to the fifth surface 141a. The sixth surface 141b may be a fastening surface for fastening with the first holder 130. The second holder 140 may be a circular plate having a second through hole PH2. When the first holder 130 and the second holder 140 are fastened to each other by fastening bolts, the first through hole PH1 and the second through hole PH2 may be aligned with each other. Accordingly, light traveling through the through passage SH of the hollow motor 102 may pass through the adapter through hole AH, the first through hole PH1, and the second through hole PH2. The motor adapter 120, the first holder 130, and the second holder 140 may each include a metal plate containing a metal such as aluminum or a plastic plate containing plastic.

The fastening surface 141b, that is, the sixth surface 141b of the second holder 140 may be provided with a polarizer receiving groove 142 for accommodating the polarizer 150. The polarizer receiving groove 142 may be a recess in the sixth surface 141b of the second holder 140. The polarizer receiving groove 142 may have a size and depth corresponding to a size and thickness of the polarizer 150. The polarizer 150 may be accommodated in the polarizer receiving groove 142 of the second holder 140. A front surface of the polarizer 150 may be arranged to face a bottom surface of the polarizer receiving groove 142 of the second holder 140. Accordingly, when the polarizer 150 is disposed in the polarizer receiving groove 142, a backside surface of the polarizer 150 may be exposed from the fastening surface 141b of the second holder 140.

First fastening holes 135 may be formed in the first holder 130, and second fastening holes 145 may be formed in the second holder 140 corresponding to the first fastening holes 135. The first and second fastening holes 135 and 145 may be screw holes having threads for coupling with fastening bolts. The polarizer 150 may be fixedly held in a sandwich manner between the first holder 130 and the second holder 140 in the polarizer receiving groove 142. The polarizer receiving groove 142 of the second holder 140 may be formed to have an assembly tolerance of about 0.1 mm in consideration of the manufacturing tolerance of the polarizer 150.

As illustrated in FIGS. 12 to 14, at least one first magnet receiving groove 123 may be formed in the attachment surface 121a of the motor adapter 120, and a first magnet 122 may be provided in the first magnet receiving groove 123. For example, the first magnet 122 may include a neodymium magnet. Four first magnet receiving grooves 123 may be arranged along a circumferential direction at equal intervals of 90 degrees with respect to a center of the motor adapter 120. The first magnet receiving groove 123 may have a circular shape. The first magnet receiving groove 123 may have a first depth DI from the attachment surface 121a. The first magnet 122 may have a circular shape corresponding to the first magnet receiving groove 123. The first magnet 122 may have a first thickness T1. The first thickness Tl may be smaller than the first depth D1. Accordingly, an upper surface of the magnet 122 may be positioned lower than the attachment surface 121a.

At least one alignment pin 124 may be provided on the attachment surface 121a of the motor adapter 120. The alignment pin 124 may protrude from the attachment surface 121a to have a preset height. A distal end of the alignment pin 124 may have a tapered shape. For example, four alignment pins 124 may be arranged along the circumferential direction at equal intervals of 90 degrees with respect to the center of the motor adapter 120.

As illustrated in FIGS. 15 to 17, at least one second magnet receiving groove 133 may be provided in the attachment surface 131b of the first holder 130 corresponding to the at least one first magnet receiving groove 123, and a second magnet 132 may be provided in the second magnet receiving groove 133. For example, the second magnet 132 may include a neodymium magnet. Four second magnet receiving grooves 133 may be arranged along a circumferential direction at equal intervals of 90 degrees with respect to a center of the first holder 130. The second magnet receiving groove 133 may have a circular shape. The second magnet receiving groove 133 may have a second depth D2 from the attachment surface 131b. The second magnet 132 may have a circular shape corresponding to the second magnet receiving groove 133. The second magnet 132 may have a second thickness T2. The second thickness T2 may be smaller than the second depth D2. Accordingly, an upper surface of the second magnet 132 may be positioned lower than the attachment surface 131b.

At least one alignment pin hole 134 may be provided in the attachment surface 131b of the first holder 130 corresponding to the at least one alignment pin 124. The alignment pin hole 134 may be formed to have a preset depth from the attachment surface 131b. The alignment pin hole 134 may have a shape that can accommodate the distal end of the alignment pin 124. For example, four alignment pin holes 134 may be arranged along the circumferential direction at equal intervals of 90 degrees with respect to the center of the first holder 130.

The first holder 130 of the polarizer holder PH may be attached to the motor adapter 120 by magnetic force. The first holder 130 may be detachably attached to the motor adapter 120 by attractive forces between the second magnets 132 of the first holder 130 and the first magnets 122 of the motor adapter 120. When the first holder 130 is attached to the motor adapter 120, the alignment pins 124 of the motor adapter 120 may be inserted into the alignment pin holes 134 of the first holder 130, to thereby improve assembly precisions. In addition, since the upper surfaces of the first magnet 122 and the second magnet 132 are located lower than the attachment surfaces 121a and 131b, when the first holder 130 is attached to the motor adapter 120, an air gap may be formed between the first and second magnets 122 and 132 to eliminate effects due to tolerances that may occur when assembling the magnets.

In addition, a groove 136 may be formed in the fastening surface 131a of the first holder 130 and may extend along a circumference of the first through hole PH1, and an O-ring 137 may be provided in the groove 136. When the first holder 130 and the second holder 140 are fastened to each other, the O-ring 137 may press the exposed backside surface of the polarizer 150 to firmly support the polarizer 150. For example, the O-ring 137 may include a fluoro rubber such as Viton™M. The O-ring may be used at a temperature of about −40° C. to 250° C., and may contain materials with excellent resistance to aromatic compounds and various organic solvents and chemicals.

The O-ring 137 may press the polarizer 150 through surface contact, and the pressed polarizer 150 may be in contact with the bottom surface of the polarizer receiving groove 142 of the second holder 140 having guaranteed flatness, to thereby prevent tilting or twisting of the polarizer 150. Additionally, damage may be prevented when mounting the polarizer 150 by using an elastic material such as the O-ring.

As illustrated in FIGS. 18 and 19, at least one position adjustment hole 146 may be formed in the polarizer receiving groove 142. The position adjustment hole 146 may penetrate the second holder 140. After the polarizer 150 is fixedly held between the first holder 130 and the second holder 140 by fastening bolts, the position, tilt, etc. of the polarizer 150 may be adjusted through the position adjustment hole 146. For example, the position adjustment hole may allow access through the second holder 140 to adjust the position, tilt, etc. of the polarizer 150 by manually manipulating the polarizer 150.

As illustrated in FIGS. 9, 13, and 14, an eccentricity prevention protrusion 126 may be formed on the fastening surface 121b of the motor adapter 120 and may protrude along a circumference of the adapter through hole AH. The eccentricity prevention protrusion 126 may protrude from the fastening surface 121b to have a preset height. When the motor adapter 120 is mounted on one surface of the rotating part 104 of the hollow motor 102, the eccentricity prevention protrusion 126 may be accommodated in an annular-shaped protrusion receiving groove 106 that is formed in one surface of the rotating part 104, to thereby prevent the motor adapter 120 from being mounted eccentrically to the hollow motor 102.

A plurality of third fastening holes 127 may be formed in the eccentricity prevention protrusion 126 and may be spaced apart from each other along the circumferential direction. For example, six third fastening holes 127 may be arranged along the circumferential direction at equal intervals of 60 degrees with respect to the center of the motor adapter 120. Six fourth fastening holes 108 may be formed in the protrusion receiving groove 106 of the rotating part 104 to be arranged along a circumferential direction at equal intervals of 60 degrees with respect to a center of the hollow SH. Accordingly, the motor adapter 120 may be fixedly installed on the rotating part 104 of the hollow motor 102 by coupling the fastening bolts to the third and fourth fastening holes 127 and 108.

As described above, each of the polarizer assemblies 100a and 100b may include the polarizer holder assembly 110 that is detachably mounted on the hollow motor 102. The polarizer holder assembly 110 may include the motor adapter 120 that is mounted on one surface of the rotating part 104 of the hollow motor 102 and the polarizer holder PH that is detachably attached to the motor adapter 120 by magnetic force. The polarizer holder PH may include the first holder 130 and the second holder 140 that are fastened to each other by fastening bolts to fixedly hold the polarizer 150 therebetween.

The polarizer holder PH may be assembled to fixedly hold the polarizer 150 in a sandwich manner outside the facility, and the assembled polarizer holder PH may be attached to the motor adapter 120 by magnetic force rather than by bolt fastening. Accordingly, component assembly, assembly precision, and repeatability may be improved.

In addition, the O-ring 137 may be pressed through surface contact with the polarizer 150, and the pressed polarizer 150 may be aligned with the bottom surface of the polarizer receiving groove 142 of the second holder 140 having the guaranteed flatness, to thereby prevent tilting or twisting of the polarizer 150 and prevent damage when the polarizer 150 is installed.

The above spectroscopic ellipsometer may be used to manufacture a semiconductor package including semiconductor devices such as logic devices or memory devices. The semiconductor package may include logic devices such as central processing units (CPUs), main processing units (MPUs), or application processors (APs), or the like, and volatile memory devices such as DRAM devices, HBM devices, or non-volatile memory devices such as flash memory devices, PRAM devices, MRAM devices, ReRAM devices, or the like.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims.

What is claimed is:

1. A polarizer assembly, comprising:
a hollow motor having a rotating part and a through passage extending therethrough;
a motor adapter mounted on a surface of the rotating part of the hollow motor, the motor adapter having a coupling surface facing the hollow motor, a first attachment surface opposite the coupling surface, and an adapter through hole aligned with the through passage of the hollow motor and through which light traveling through the hollow motor passes; and
a polarizer holder having a first holder and a second holder that are fastened to each other to fixedly hold a polarizer between a first fastening surface of the first holder and a second fastening surface of the second holder that opposes the first fastening surface, the first holder and the second holder respectively having a first through hole and a second through hole that are aligned with each other when the first holder and the second holder are fastened to each other, and the polarizer holder having a second attachment surface facing the first attachment surface,
wherein a first magnet is provided in the first attachment surface and a second magnet is provided in the second attachment surface such that the polarizer holder is detachably attached to the motor adapter by magnetic force between the first magnet and the second magnet.

2. The polarizer assembly of claim 1, wherein at least one alignment pin is provided on the first attachment surface, at least one alignment pin hole corresponding to the at least one alignment pin is provided on the second attachment surface, and the at least one alignment pin is inserted into the at least one alignment pin hole.

3. The polarizer assembly of claim 1, wherein the first magnet is a neodymium magnet.

4. The polarizer assembly of claim 1, wherein the first attachment surface includes a first magnet receiving groove accommodating the first magnet and the second attachment surface includes a second magnet receiving groove accommodating the second magnet.

5. The polarizer assembly of claim 1, wherein a polarizer receiving groove for accommodating the polarizer is provided in the second fastening surface of the second holder.

6. The polarizer assembly of claim 5, wherein the polarizer receiving groove has at least one position adjustment hole formed therein for adjusting a position of the polarizer.

7. The polarizer assembly of claim 1, wherein a groove is formed in the first fastening surface of the first holder along a circumference of the first through hole, and an O-ring is disposed in the groove to press a surface of the polarizer when the first holder and the second holder are fastened to each other.

8. The polarizer assembly of claim 7, wherein the O-ring comprises a fluoro rubber.

9. The polarizer assembly of claim 1, wherein an eccentricity prevention protrusion is formed on the coupling surface of the motor adapter and protrudes along a circumference of the adapter through hole.

10. The polarizer assembly of claim 9, wherein a plurality of fastening holes are formed in the eccentricity prevention protrusion and are spaced apart from each other along a circumferential direction.

11. A polarizer assembly, comprising:
a motor adapter having a coupling surface for fixedly attaching to a surface of a rotating part of a hollow motor and having an adapter through hole through which light traveling through the hollow motor passes;
a first holder detachably attached to the motor adapter, the first holder having a first through hole that is aligned with the adapter through hole when the first holder is attached to the motor adapter;
a second holder fastened to the first holder, the second holder having a second through hole that is aligned with the first through hole when the second holder is fastened to the first holder; and
a polarizer fixedly held between the first holder and the second holder that are fastened to each other,
wherein at least one magnet is provided in each of attachment surfaces of the motor adapter and the first holder that face each other such that the first holder is detachably attached to the motor adapter by magnetic force between the at least one magnet provided in each of the first holder and the second holder.

12. The polarizer assembly of claim 11, wherein at least one alignment pin is provided on the coupling surface of the motor adapter, at least one alignment pin hole corresponding to the at least one alignment pin is provided on an attachment surface of the first holder, and the at least one alignment pin is inserted into the at least one alignment pin hole.

13. The polarizer assembly of claim 11, wherein the at least one magnet includes a neodymium magnet.

14. The polarizer assembly of claim 11, wherein at least one magnet receiving groove accommodating the at least one magnet is provided in each of the attachment surfaces of the motor adapter and the first holder.

15. The polarizer assembly of claim 14, wherein a thickness of the at least one magnet is smaller than a depth of the at least one magnet receiving groove.

16. The polarizer assembly according to claim 11, wherein a polarizer receiving groove accommodating the polarizer is provided in a fastening surface of the second holder.

17. The polarizer assembly of claim 11, wherein a groove is formed in a fastening surface of the first holder along a circumference of the first through hole, and an O-ring is disposed in the groove to press a surface of the polarizer when the first holder and the second holder are fastened to each other.

18. The polarizer assembly of claim 11, wherein an eccentricity prevention protrusion is formed on a fastening surface of the motor adapter that faces the surface of the rotating part of the hollow motor and protrudes along a circumference of the adapter through hole.

19. The polarizer assembly of claim 18, wherein a plurality of fastening holes are formed in the eccentricity prevention protrusion and are spaced apart from each other along a circumferential direction.

20. A polarizer assembly, comprising:
a motor adapter having a coupling surface for attaching to a rotating part of a hollow motor, the motor adapter having an adapter through hole through which light traveling through the hollow motor passes; and
a polarizer frame having a first holder and a second holder that are fastened to each other to fixedly hold a polarizer between opposing fastening surfaces of the first holder and the second holder, the first holder and the second holder respectively having a first through hole and a second through hole that are aligned with each other when the first holder and the second holder are fastened to each other,
wherein at least one magnet is provided in each of attachment surfaces of the motor adapter and the first holder that face each other such that the polarizer frame is detachably attached to the motor adapter by magnetic force between the at least one magnet is provided in each of the attachment surfaces of the motor adapter and the first holder, and
wherein at least one alignment pin is provided on an attachment surface of the motor adapter, and at least one alignment pin hole into which the at least one alignment pin is inserted is provided in the attachment surface of the first holder.
